(19) United States
(12) Patent Application Publication
(10) Pub. No.: US 2003/0122465 A1
(43) Pub. Date: Jul. 3, 2003

(54) Decorative bulb with multiple light points and double circuits

(76) Inventor: Yu-Lin Wu, Hsinchu (TW)

Correspondence Address: TROXELL LAW OFFICE PLLC, SUITE 1404, 5205 LEESBURG PIKE, FALLS CHURCH, VA, 22041, US

(21) Appl. No.: 10/028,282

(22) Filed: Dec. 28, 2001

(51) Int. Cl. H01J 19/42

(52) U.S. Cl. 313/272

(57) ABSTRACT

Decorative bulb with multiple light points and double circuits, including a vacuumized glass-made transparent housing in which an insulating bead is disposed. Two sets of leads are separately located on the bead. Two tungsten filaments are respectively fixedly connected between the portions of the two sets of leads extending into the housing. The two tungsten filaments are respectively positioned in a front and a rear positions. The portions of the two sets of leads extending out of the housing are connected to the double circuits for controlling powering on/off of the bulb. Accordingly, one single decorative bulb has multiple light points insides, which can be respectively controlled to achieve various light-emitting decorative effects.

### BACKGROUND OF THE INVENTION

The present invention is related to a decorative bulb with multiple light points and double circuits. One single such decorative bulb has multiple light points which can be respectively controlled to achieve various light-emitting decorative effects.

A conventional Christmas bulb string includes a number of bulbs serially connected with each other to form a certain length of bulb string. Such conventional Christmas bulb has a vacuumized glass-made housing in which an insulating bead is disposed. Two metal leads (generally are magnesium-plated filaments) are separately located on the insulating bead. A light-emitting tungsten filament is fixed between the two leads. A bimetal blade is disposed in the housing. After a period of lighting, the bimetal blade is bent to open the circuit and after cooled, the bimetal is again straightened to power on the bulb for emitting light. Therefore, the Christmas bulb string can flicker.

The above conventional decorative bulbs are easily manufactured at low cost so that they are widely used in various kinds of toys, indicator lamps and Christmas lights.

U.S. Pat. No. 4,812,956 discloses a flexible lamp-string device having a flexible inner hose formed with multiple radial holes at intervals. Multiple decorative bulbs are respectively placed in the radial holes to form the bulb string. Over two leads are connected to the flexible inner hose and housed by a transparent PVC tube to form a flexible light hose. The light hose can be cut into a certain length and used in various sites.

In addition, U.S. Pat. Nos. 5,662,409, 5,800,046 and 5,951,146 disclose net light or knitting light in which the bulb string is knitted on a net to form a picture. An external IC box is used to control the net to form various decorative pictures. Such net light or knitting light employs a large number of the conventional decorative bulbs manufactured at low cost.

However, the conventional decorative bulb employs a monotonous light-emitting structure as shown in FIG. 1. That is, an insulating bead 11 is disposed in the glass-made housing 10 and two leads 12, 13 are separately located on the insulating bead. A light-emitting tungsten filament 14 is fixed between the two leads. A fuse 15 can be added between the two leads as necessary. The top end of the housing 10 can be a sharp head, round head or flat head. The tungsten filament 14 can be soldered between the two leads in an oblique, arched or plane state as shown in FIG. 1. Preferably, the tungsten filament 14 is soldered in an oblique state. This is because that the tungsten filament 14 is elongated in accordance with the resistance value so as to prevent the tungsten filament 14 from suspending to touch and blacken the housing.

FIG. 2 shows an improved decorative bulb. An upper and a lower separated tungsten filaments 140, 141 are fixedly connected between the two leads to form two different light points in one single bulb. However, the two light points are still controlled by the same wire and lack variable light-emitting decorative effect.

### SUMMARY OF THE INVENTION

It is therefore a primary object of the present invention to provide a decorative bulb with multiple light points and double circuits, including a vacuumized glass-made transparent housing in which an insulating bead is disposed. Two sets of leads are separately located on the bead. Two tungsten filaments are respectively fixedly connected between the portions of the two sets of leads extending into the housing. The two tungsten filaments are respectively positioned in a front lower and a rear higher positions. The portions of the two sets of leads extending out of the housing are connected to the double circuits for controlling powering on/off of the bulb. Accordingly, in cooperation with a mother bulb or electronic flickering control device, one single decorative bulb can have multiple light points insides, which can be respectively controlled to achieve various light-emitting decorative effects as follows:

The upper and lower tungsten filaments both light;

The upper and lower tungsten filaments sequentially or reversely light;

The upper tungsten filament always flickers, while the lower tungsten filament always lights or the lower tungsten filament always flickers, while the upper tungsten filament is always lights;

The upper and lower tungsten filaments both flicker; and

The upper and lower tungsten filaments by turns flicker and light.

The present invention can be best understood through the following description and accompanying drawings wherein:

### BRIEF DESCRIPTION OF THE DRAWINGS

FIG. 1 is a perspective view of a conventional decorative bulb with single tungsten filament;

FIG. 2 is a perspective view of a conventional decorative bulb with double tungsten filament;

FIG. 3 is a perspective view of a preferred embodiment of the decorative bulb of the present invention;

FIG. 4 is a front view according to FIG. 3; and

FIG. 5 is a side view according to FIG. 4.

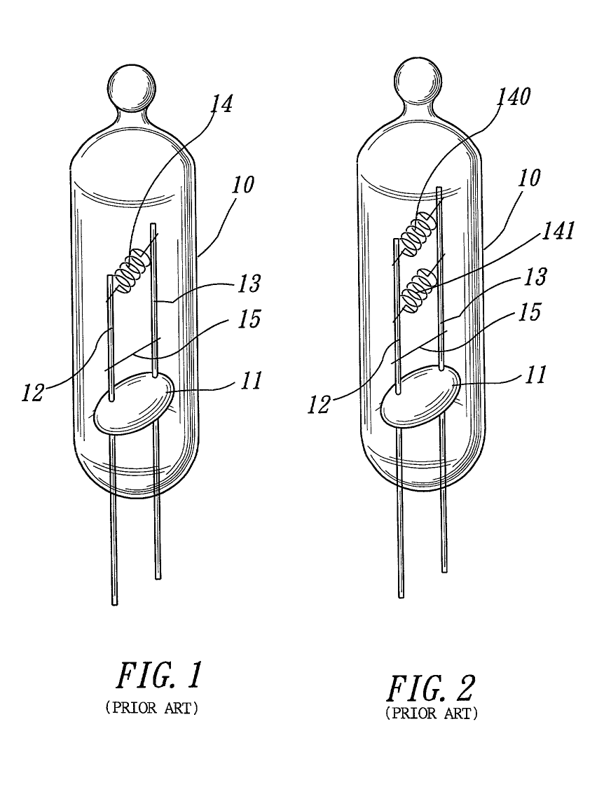

### DETAILED DESCRIPTION OF THE PREFERRED EMBODIMENTS

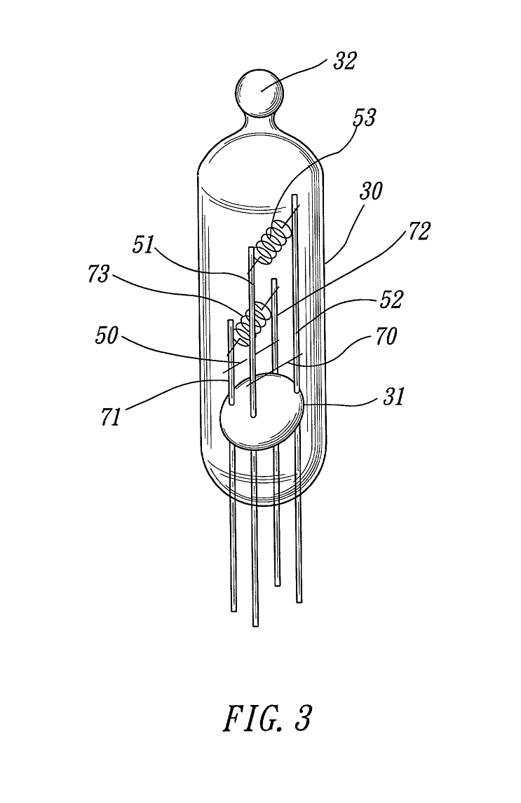

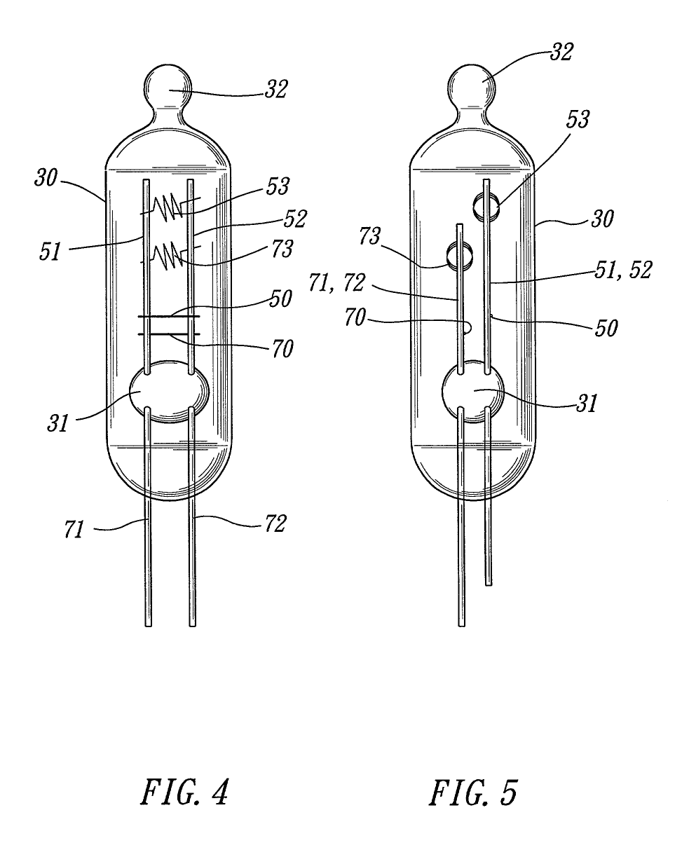

Please refer to FIG. 3. The present invention also includes a vacuumized glass-made transparent housing 30 in which an insulating bead 31 is disposed. The top end 32 of the housing 30 can be a sharp head, round head or flat head.

The present invention is characterized in that two sets of leads (magnesium-plated filaments) 51, 52, 71, 72 are separately located on the bead 31. Respective tungsten filaments 53, 73 are fixedly connected to the portions of the leads 51, 52, 71, 72 extending into the housing 30. Fuses 50, 70 can be connected to the leads as necessary. The tungsten filaments 53, 73 are preferably soldered between the leads in an oblique, plane or arched state as shown in FIG. 3.

In a preferred embodiment, the first set of separated leads 51, 52 are positioned in a rear higher position, while the second set of separated leads 71, 72 are positioned in a front and lower position. Accordingly, the tungsten filaments 53, 73 soldered between the leads are preferably respectively positioned in a front lower and a rear higher positions.

The portions of the leads 51, 52, 71, 72 extending out of the transparent housing 30 are externally connected to double circuits for controlling powering on/off of the bulb. Alternatively, after the bulbs are serially connected to form the bulb string, the bulb string is cooperatively connected with a mother bulb or electronic flickering control device for controlling the flickering of the bulbs.

The improved decorative bulbs of the present invention can be used in the above bulb string, flexible light hose or net light to at least achieve the variations as follows:

a) The upper and lower tungsten filaments 53, 73 both light.

b) The upper and lower tungsten filaments 53, 73 sequentially or reversely light.

c) The upper tungsten filament 53 always flickers, while the lower tungsten filament 73 always lights or the lower tungsten filament 73 always flickers, while the upper tungsten filament 53 is always lights.

d) The upper and lower tungsten filaments 53, 73 both flicker.

e) The upper and lower tungsten filaments 53, 73 by turns flicker and light.

Accordingly, the decorative bulbs of the present invention can form multiple light points and various light-emitting effects so that the decorative effect is greatly enhanced.

The above embodiments are only used to illustrate the present invention, not intended to limit the scope thereof. Many modifications of the above embodiments can be made without departing from the spirit of the present invention, such as changing figures of the housing.

What is claimed is:

1. Decorative bulb with multiple light points and double circuits, comprising a vacuumized glass-made transparent housing in which an insulating bead is disposed, two sets of leads being separately located on the bead, two tungsten filaments being respectively fixedly connected between the portions of the two sets of leads extending into the housing, the two tungsten filaments being respectively positioned in a front and a rear positions, the portions of the two sets of leads extending out of the housing being connected to the double circuits for controlling powering on/off of the bulb.

2. Decorative bulb with multiple light points and double circuits as claimed in claim 1, wherein the two tungsten filaments are respectively connected between the two sets of leads and positioned in a front lower and a rear higher positions.

3. Decorative bulb with multiple light points and double circuits as claimed in claim 1, wherein fuses are selectively additionally connected between the tungsten filaments and the insulating bead.
